(19) United States
(12) Patent Application Publication
(10) Pub. No.: US 2016/0327787 A1
(43) Pub. Date: Nov. 10, 2016

(54) VANISHING MIRROR SYSTEM WITH INVISIBLE CONTROL APPARATUSES AND METHODS

(71) Applicant: ELECTRIC MIRROR, LLC, Everett, WA (US)

(72) Inventors: James V. Mischel, SR., Lynnwood, WA (US); Michael Martin Uhl, Seattle, WA (US)

(73) Assignee: ELECTRIC MIRROR, LLC, Everett, WA (US)

(21) Appl. No.: 14/708,187

(22) Filed: May 9, 2015

(51) Int. Cl. G02B 27/01; F21V 23/00; G01J 1/44; F21V 8/00

(52) U.S. Cl. CPC G02B 27/0101; G02B 6/0001; F21V 23/005; G01J 1/44

(57) ABSTRACT

A vanishing system and methods include a first glass layer which has a front side, a back side, a viewing area, and a reflective area the viewing area is substantially transparent. The vanishing system includes a second glass layer. The second glass layer has a front side, a back side, and a partially reflective layer, the partially reflective layer is in contact with one of the front side of the second glass layer or the back side of the second glass layer. The second glass layer covers the viewing area on the back side of the first glass layer. A sensor has a length and a width. The sensor is located on the back side of the second glass layer. The first glass layer and the second glass layer are coupled together.

### BACKGROUND OF THE INVENTION

1. Field of Invention

The invention relates generally to vanishing systems for mirrors, and more specifically to apparatuses and methods for providing communication with a user through a mirror.

2. Art Background

Various electronics have been embedded with mirrors such as a media display screen, lighting, sound, defoggers, etc. Referring to FIG. 1, a glass layer 102 with electronics 160 embedded therein is displayed generally at 100 and 150. A cross-sectional view of the glass layer 102 is illustrated generally at 150. The glass layer 102 typically has a reflective portion 108 and a viewing area 104/154 where a media display device 160 is viewed. Wireless methods of control are typically used to power the embedded electronics on and off. One form of wireless control uses the infrared portion of the electromagnetic spectrum. An infrared control system includes an infrared sensor 158 that receives control signals from a control that a user uses to operate the electronics. In order to facilitate reception of the infrared signal, one or more areas of the mirror silvering are removed as indicated by 110 and 112 (shown in 100) and 156 (shown in 150) (de-silvered), thereby allowing the infrared signals to pass through the glass layer 102 and be received by the infrared sensor 158. Such de-silvered areas 110, 112 present visible marks on the mirror's surface which can be considered as unsightly and or distracting to the user since they are always visible, this can present a problem.

In addition to the de-silvered area prepared for infrared signals, one or more additional de-silvered areas, such as 112 are created in the glass layer 102 to permit an indicator light to transmit light to the user which indicates that the electronics are being powered up or down or is on. Such de-silvered areas 112 provide continuous variation in the otherwise smooth and homogenous surface of the glass layer 102. These de-silvered areas can be distracting to a user since they provide deviation from the uniform glass layer surface. In addition these areas are sometimes mistaken for a camera that is thought to be filming the user. All of this can present a problem.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings, in which like references indicate similar elements.

FIG. 1 shows an example of an appearance of a front side of a glass layer utilizing an existing system for control using wireless signals and the accompanying cross sectional view of the glass layer.

FIG. 2 illustrates examples of appearances of a front side of glass layers utilizing a vanishing system according to embodiments of the invention.

FIG. 3 illustrates an example of an appearance of a front side of a glass layer and the accompanying partial cross-sectional view, according to embodiments of the invention.

FIG. 4 illustrates a sensor assembly, according to embodiments of the invention.

FIG. 5A illustrates placement of a sensor assembly relative to a viewing area of a media display device, according to embodiments of the invention.

FIG. 5B illustrates alternative placement of a sensor assembly relative to a viewing area of a media display device, according to embodiments of the invention.

FIG. 6A illustrates alternative embodiments of a vanishing system for a glass layer in exploded partial cross-sectional view, according to embodiments of the invention.

FIG. 6B illustrates the vanishing system from FIG. 6A in assembled view, according to embodiments of the invention.

FIG. 7 illustrates a close-up view of a sensor, from FIG. 6A or FIG. 6B, according to embodiments of the invention.

FIG. 8 illustrates a close-up view of a light indicator assembly, from FIG. 6A or FIG. 6B, according to embodiments of the invention.

FIG. 9 illustrates a plurality of light sources according to embodiments of the invention.

FIG. 10 illustrates a light guide according to embodiments of the invention.

FIG. 11 illustrates a cross-sectional view of an indicator light assembly according to embodiments of the invention.

FIG. 12 illustrates different placements for a light guide according to embodiments of the invention.

FIG. 13A and FIG. 13B illustrate combining a sensor and an indicator light, according to embodiments of the invention.

FIG. 14 illustrates a process to form an indicator light assembly according to embodiments of the invention.

FIG. 15 illustrates a process to form a sensor assembly according to embodiments of the invention

FIG. 16 illustrates a process to create a vanishing mirror system according to embodiments of the invention.

FIG. 17 illustrates a block diagram of a control system for electronics, according to embodiments of the invention.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense, and the scope of the invention is defined only by the appended claims.

A disappearing system for a glass layer assembly is described. The disappearing system permits electronic control signals to pass through a glass layer at locations which are invisible to the user. In various embodiments, part of the disappearing system includes a media display device which is visible when powered up and then blends into a glass layer when powered off. Electronics “ON” or “OFF” indication lights appear in the glass layer and then disappear conveying a feeling that the light originates from an invisible source. The terms “glass layer” and “mirror” are used interchangeably within this description of embodiments. However, it is to be understood that a glass layer is not always configured as a mirror. In some embodiments, a glass layer is transparent. In addition, a glass layer can have different degrees of reflectivity across the glass layer. For example, within a portion of a mirror, there is little or no reflectivity such that the portion of the mirror is non-reflective.

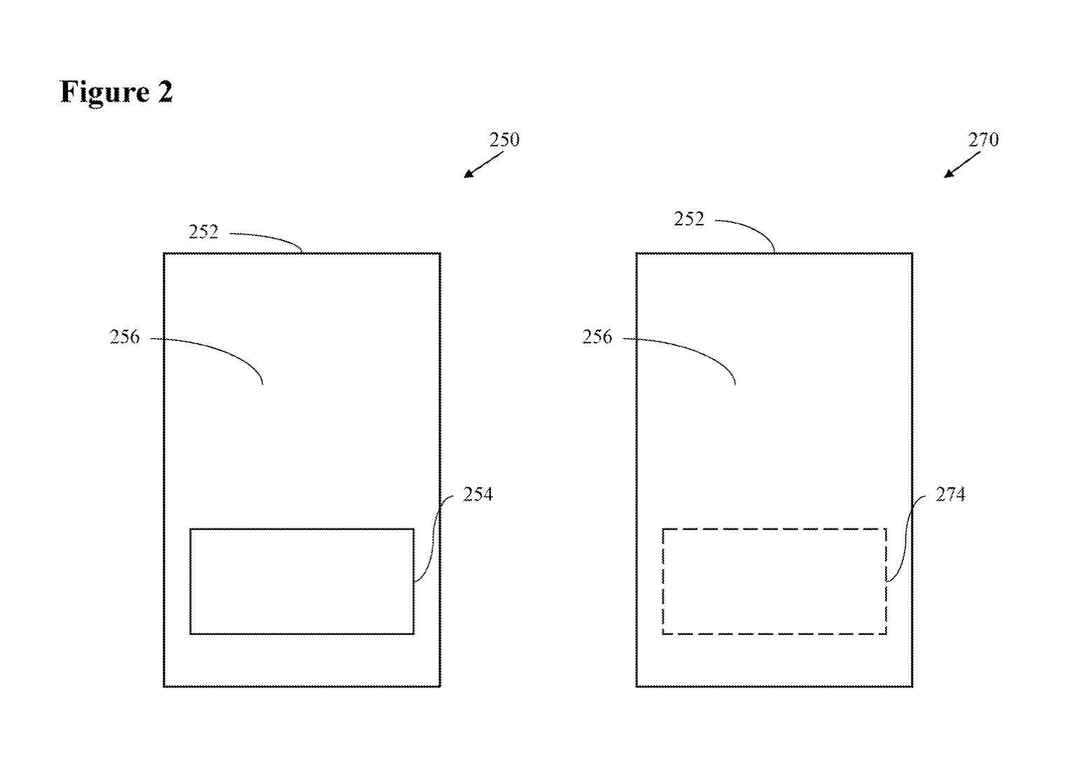

FIG. 2 illustrates, generally at 250 and 270, examples of appearances of a front side of glass layers utilizing a vanishing system according to embodiments of the invention. With reference to FIG. 2 at 250, a glass layer 252, made from a continuous piece of glass, has a reflective portion 256 and a viewing portion 254. The viewing portion 254 is an area of the glass layer 252 through which a media display device can be viewed. According to processes and apparatuses taught herein, the de-silvered areas formerly used to permit signals to pass therethrough and to provide a visual indicator of device power up and/or down transient or power state have been rendered invisible to the user viewing the mirror from the front side as illustrated in FIG. 2. In some embodiments, such as that illustrated at 250, the viewing area 254 can remain visible when the media display device (shown in figures to follow) is powered down as indicated by the solid line used to render the rectangle of 254. In other embodiments, the viewing portion vanishes into the glass layer 252 when the media display device is powered down, such as is indicated at 274 by the dashed line.

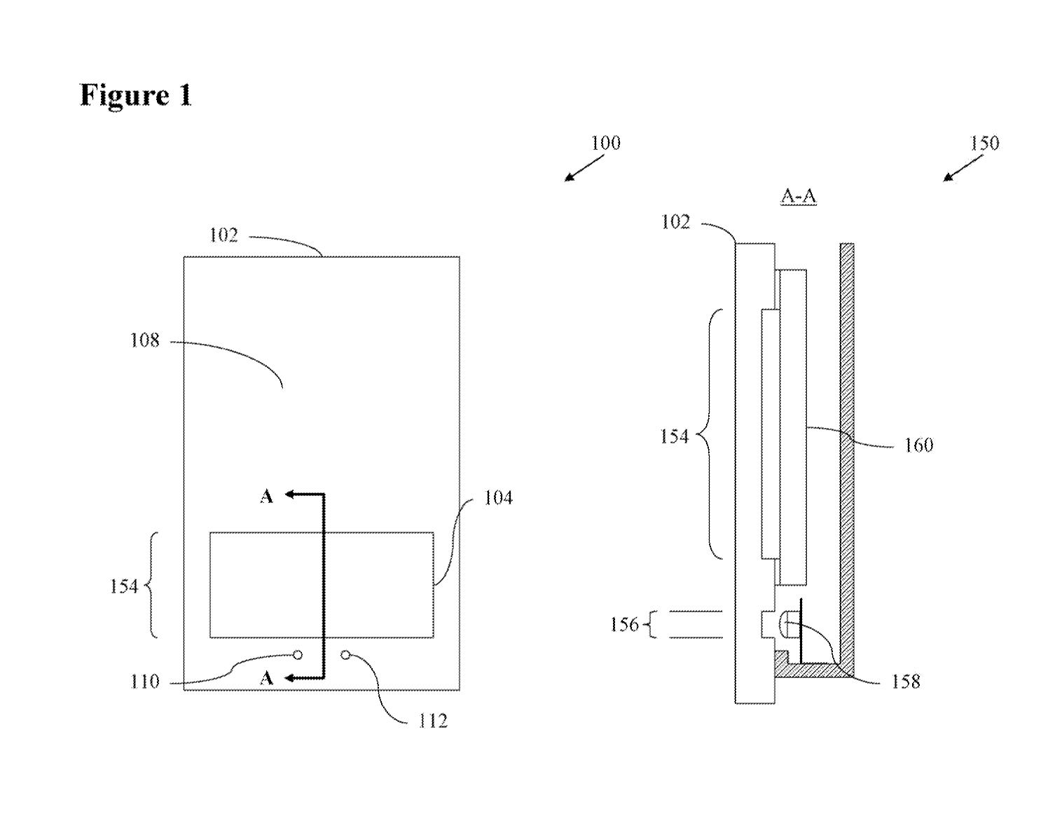

Referring to FIG. 2 at 270 the glass layer 252 has a viewing portion 274 that vanishes when the media display device is in the OFF state as indicated by the dashed line used for 274. When the media display device associated with viewing area 274 is in an OFF state the glass layer 252 appears as one continuous reflective piece of glass 256 free from the de-silvered areas such as 110 and or 112 (FIG. 1).

Other electronics can be incorporated for use with glass layer 252 in addition to or in lieu of a media display device. For example, a mirror defogger can be incorporated with the glass layer 252 and controlled with the vanishing systems described herein according to various embodiments of the invention. In other embodiments, devices used to generate sound such as a speaker or a transducer can be implemented and operated with the vanishing systems described herein according to embodiments of the invention. In yet other embodiments, lighting (not shown to preserve clarity in the figures) is incorporated into the glass layer 252 as either direct light or backlight or a combination of both. The lighting is controlled with the vanishing systems for the glass layer 252. The vanishing systems are used to render invisible the areas of the glass layer used for transmission of wireless control signals, system state indication status, and a viewing area for a media display device when present.

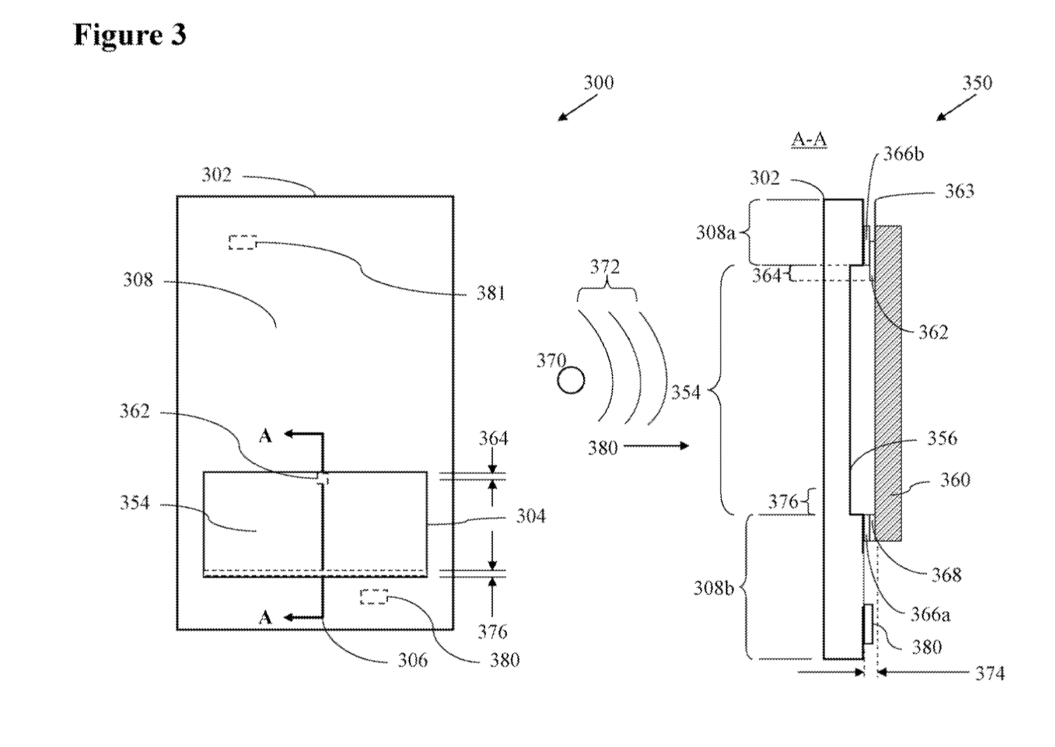

FIG. 3 illustrates an example of an appearance of a front side of a glass layer and the accompanying cross-sectional view, according to embodiments of the invention. With reference to FIG. 3 at 300, a glass layer 302 has a reflective portion 308 and in some embodiments, a viewing portion 304. A cross-sectional view A-A 306 is presented in FIG. 3 at 350. With reference to 350, the glass layer 302 has a reflective area indicated by 308a and 308b (which is a representative portion of 308 from 300) and a viewing area indicated at 354. In some embodiments, a reflective layer (and backing layer if present) has been removed (de-silvered) from a back side 356 of the glass layer 302 over an area indicated by 354 in order to create the viewing area 354, rendering the viewing area virtually transparent. In other embodiments, a reflective layer is not completely removed from the back side 356 of the glass layer 302. In such embodiments, the reflectivity of the glass layer 302 is reduced across the viewing area relative to the reflectivity of the reflective area 308a/308b. Embodiments of the invention permit a limitless number of different reductions in reflectivity of the viewing area 354 relative to the reflective area 308a/308b (which is a representative portion of 308 from 300). A non-limiting example of a reflectivity of the reflective area is a reflectivity of approximately 50%. Many different values can be used for this reflectivity and embodiments of the invention are not limited by a value selected. In various embodiments, reflectivities can range from zero up to a value that provides two-way mirror functionality.

In some embodiments a media display device 360 is located on the back side of the glass layer 302 and the media display device 360 covers the viewing area 354. A sensor 362 for receiving wireless signals is mounted in between the glass layer 302 and the media display device 360. The sensor 362 is located within the viewing area 354 along a boundary between the viewing area 354 and the reflective area 308a. The sensor 362 extends into the viewing area by an amount indicated by 364. In various embodiments, the sensor 362 is incorporated on a mounting board 363. The mounting board 363 facilitates mechanical mounting and in some embodiments electrical connection of the sensor to circuitry not shown in the figure. In various embodiments the sensor 362 is an infrared sensor which receives wireless signals in the infrared region of the electromagnetic spectrum. In one non-limiting example a sensor has dimensions of 4 millimeters in length and 3 millimeters in width. The sensor receives signals 372 that are transmitted wirelessly from a control 370 operated by a user on a front side of the glass layer 302. In various embodiments, the sensor 362 and mounting board 363 are mounted within a sub panel or frame of the media display 360, thereby providing a flat surface for mating the media display device 360 to the glass layer 302. The view of 362/363 provided in FIG. 3 is provided for illustration only and does not limit embodiments of the invention.

A light assembly 368 is located in between the glass layer 302 and the media display device 360. The light assembly 368 is described in detail below in the figures that follow. A portion of the light assembly 368, i.e., the light guide fits into a gap 374 in between the glass layer 302 and the media display device 360. Light from the light assembly illuminates a portion of the viewing area 354 along a boundary 376 between the reflective portion 308b and the viewing portion 354. When viewed from the front side of the glass layer indicated by an arrow 380 a user observes a band of light demarcated by the boundary 376 and extending along the boundary and decaying in intensity in a direction into the viewing area 354. When the light assembly 368 is powered up, the indicator light is visible when viewed from the direction by 380. When the indicator light is powered down, light does not radiate from the light assembly. However in other embodiments, a power down cycle can initiate emission of light from the light assembly which communicates information to the user. The light assembly is described in more detail below in the figures that follow.

The media display device 360 is coupled to the glass layer 302 with attachment devices 366a/366b. The sensor 362 is coupled together with the glass layer 302 and the media display device 360. The sensor 362 can be located on the media display device 360 during a first step of assembly, followed by location of the combination of the media display device 360/sensor 362/mounting board 363 with the glass layer 302. Alternatively, the sensor 362 is coupled together with the glass layer 302 during a first step of assembly, followed by location of the combination of the glass layer 302/infrared sensor 362 with the media display device 360.

The light assembly 368 is coupled together with the glass layer 302 during a first step of assembly, followed by location of the combination of the glass layer 302/light assembly 368 with the media display device 360. Alternatively, the light assembly 368 is coupled together with the glass layer 302 and the media display device 360. The light assembly 368 can be located on the media display device 360 during a first step of assembly, followed by location of the combination of the media display device 360/light assembly 368 with the glass layer 302.

In various embodiments, a sensor 380 or 381 is located on a backside of the glass layer 302 behind the reflective portion 308 of the glass layer 302. In different embodiments, different wireless sensors are used. One non-limiting embodiment of a technology used for wireless signal transmission is the Bluetooth wireless technology standard which is also commonly known as IEEE 802.15.1 standard. A non-limiting example of a Bluetooth sensor is a model number nRF51822 from Nordic Semiconductor. In other embodiments, wireless sensors are used which are designed around the wireless signal transmission protocol known as WiFi which uses the IEEE 802.11 standard. Another non-limiting example of a wireless sensor is a sensor constructed to use the ZigBee communication protocols which are based on the IEEE 802.15.4 standard. A non-limiting example of a sensor using the ZigBee protocols is a MeshConnect™ model number ZICM35XSP0 from California Eastern Laboratories. Thus, in various embodiments, the sensor, such as 362, 380, 381 or any other sensor described herein can be one or more of an infrared sensor (IR) or a sensor utilizing a portion of the electromagnetic spectrum above the IR portion. Other wireless sensors are used in various embodiments of the invention which utilize other standards not named specifically herein. The examples stated herein are given merely for example and do not limit embodiments of the invention.

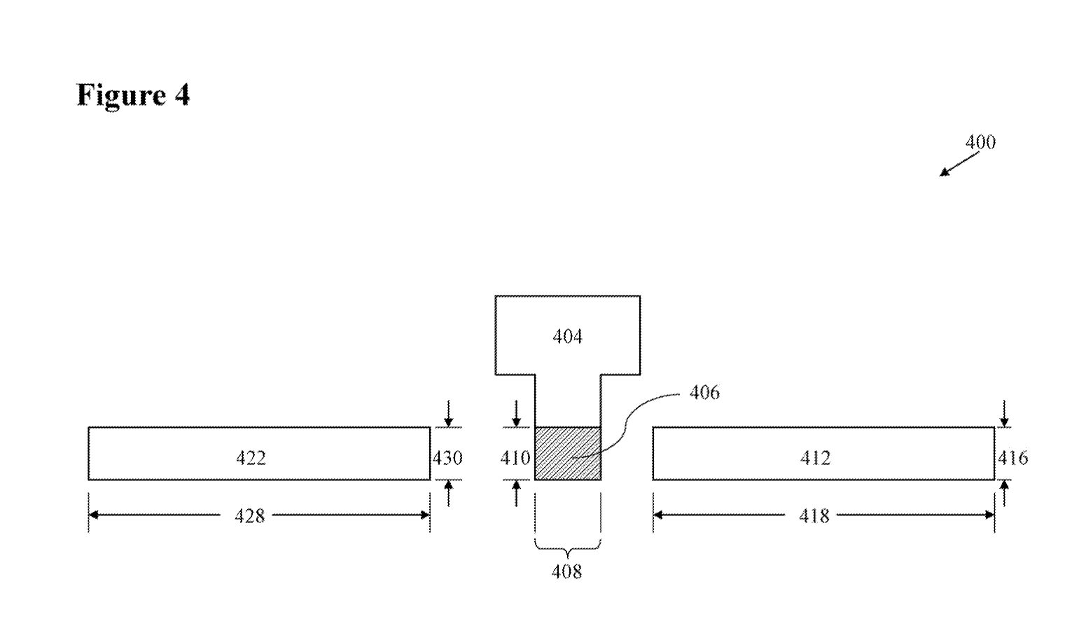

FIG. 4 illustrates, generally at 400, a sensor assembly, according to embodiments of the invention. With reference to FIG. 4, the sensor assembly 400 includes a sensor 406 incorporated with a mounting board 404. The mounting board is typically a circuit board which contains electronics necessary for the operation of the sensor 406 and the mounting board provides a structure suitable for coupling to a media display device, a glass layer, or a frame component. The sensor 406 has a length 408 and a width 410. In one non-limiting embodiment, the width 410 measures 3 millimeters and the length 408 measures 4 millimeters. Various sensors can be used for 406 or for the other sensor elements indicated in the figures herein. In one or more non-limiting examples, a wireless sensor utilizing the infrared portion (IR) of the electromagnetic spectrum is used. An example of an IR sensor is one from VISHAY® INTERTECHNOLOGY, INC. such as one of the “TSOP382 . . . ” series sensors, one of the “TSOP 384 . . . ” series sensors, one of the “TSOP572 . . . ” series sensors, one of the “TSOP574 . . . ” series sensors, etc. can be used within various embodiments of the invention.

In various embodiments, one or more dark strips can be used together with a sensor to form a uniform elongated shape. A dark strip 422 has a length 428 and a width 430. Another dark strip 412 has a length 418 and a width 416. In various embodiments, one or more dark strips are used together with a sensor to cover a portion of the viewing area along a boundary of the viewing area in either a horizontal or vertical dimension. In some embodiments, the width of the sensor 410 is substantially equivalent to the width of the dark strips 430 and 416. In various embodiments, the dark strip is made from a thin layer of substantially opaque or opaque material such as plastic, paint, etc. In various embodiments, a single dark strip is used which would combine for example 422 and 412 together and in some embodiments a notch is provided therein for the sensor 406.

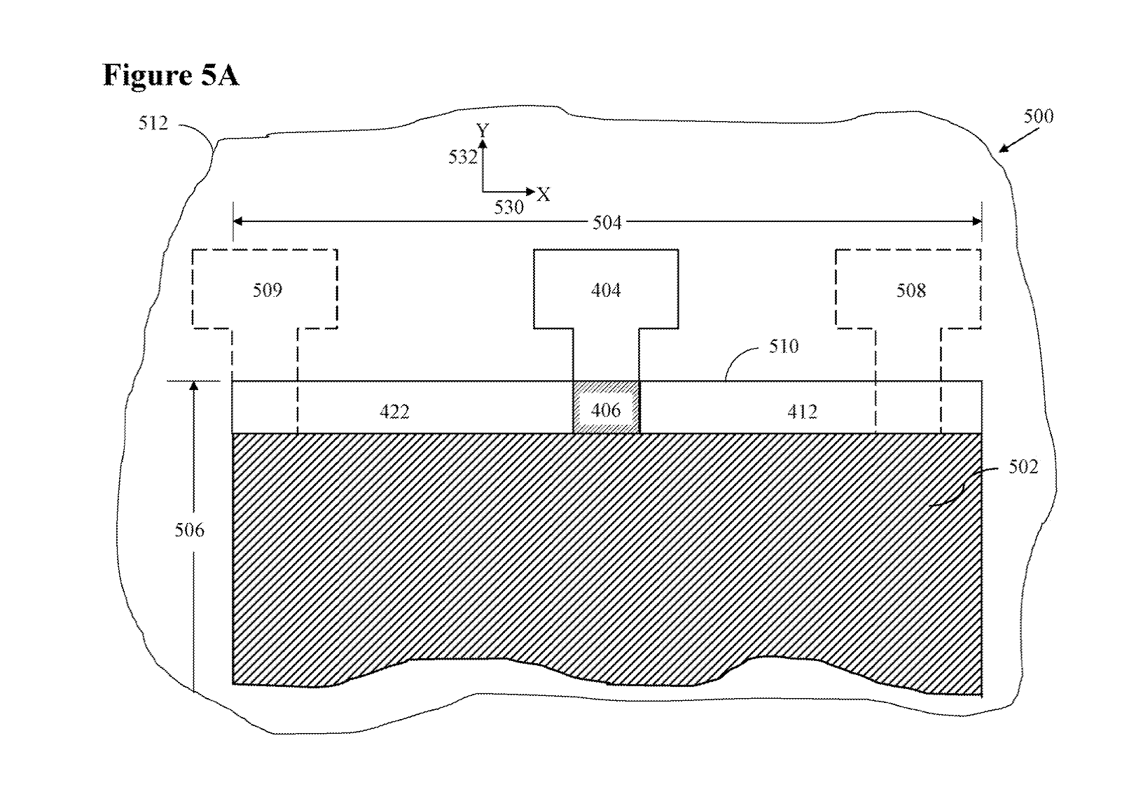

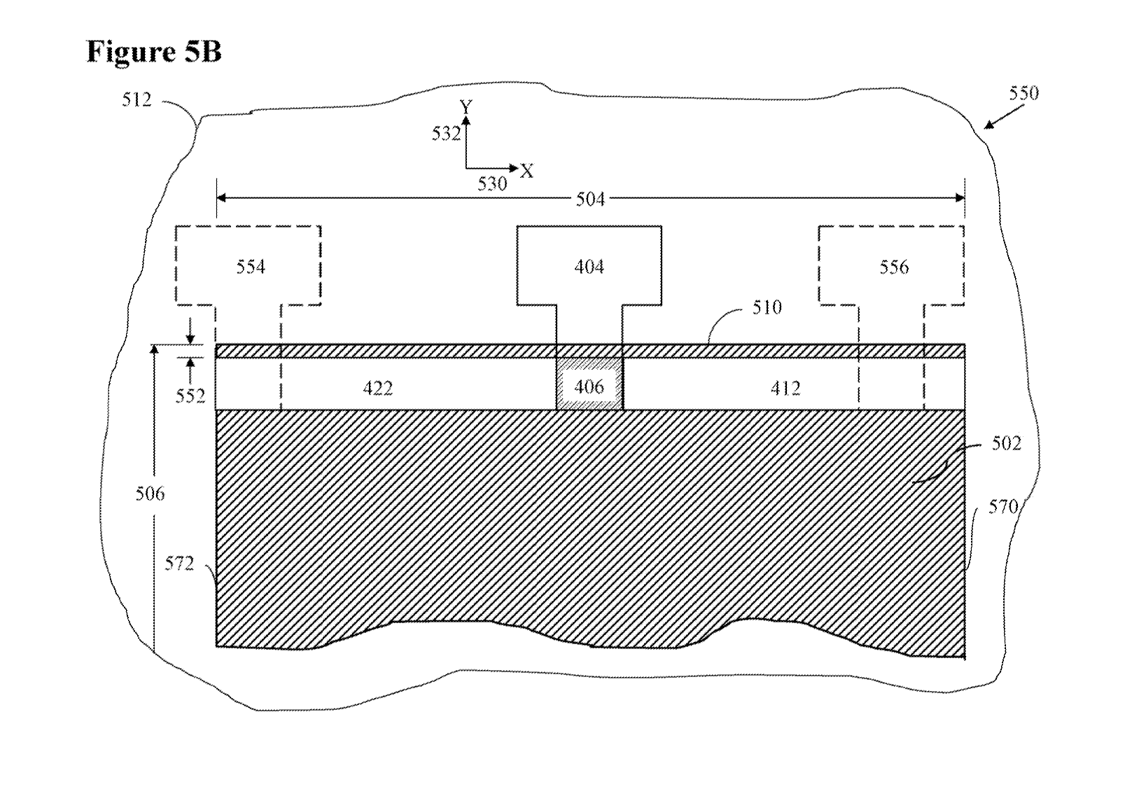

FIG. 5A illustrates, generally at 500, placement of a sensor assembly relative to a viewing area of a media display device, according to embodiments of the invention. With reference to FIG. 5A, the mounting board 404, sensor 406, and dark strips 412 and 422 (structural elements from FIG. 4) are positioned along a boundary 510 between a reflective area 512 of a glass layer and a viewing area 502. To facilitate discussion of geometry, the boundary 510 has been chosen to be parallel to an arbitrarily defined X axis 530. A corresponding orthogonal Y axis is illustrated at 532. The mounting board 404 and sensor 406 can be positioned anywhere along the boundary 510 by changing the relative lengths of the dark strips 422 and 412. For example, one of many alternative locations is shown at 508, where the lengths of the dark strips 422 and 412 would be adjusted accordingly. Any other alternative locations for the mounting board 404/sensor 406 are accomplished by suitable adjustment of the dark strips 422 and 412, such as for example 509. Note that use of dark strips is optional and in some embodiments these strips are not included. In other embodiments, more than one sensor is located along the boundary 510. Use of multiple sensors can provide a wider aperture of coverage for reception of wireless signals.

FIG. 5B illustrates, generally at 550, alternative placement of a sensor assembly relative to a viewing area of a media display device, according to embodiments of the invention. With reference to FIG. 5B, the mounting board 404, sensor 406, and dark strips 412 and 422 (elements from FIG. 4) are positioned along a boundary 510 between a reflective area 512 of a glass layer and a viewing area 502. Note that in FIG. 5B, these three elements are positioned proximate to the boundary 510 and are displaced by an amount indicated at 552 in the negative Y direction. Similar to the discussion above pertaining to FIG. 5A, the mounting board 404 and sensor 406 can be positioned anywhere along the boundary 510 by changing the relative lengths of the dark strips 422 and 412. For example, two of the many alternative locations are shown at 554 and 556, where the lengths of the dark strips 422 and 412 would be adjusted accordingly. Any other alternative location for the mounting board 404/sensor 406 is accomplished by suitable adjustment of the dark strips 422 and 412 and offset distance 552. Note that use of dark strips is optional and in some embodiments these strips are not included. Note also that offset distance 552 is optional and in some embodiments there is no offset distance.

While the discussion of mounting board and sensor placement has referred to a horizontal boundary of the viewing area, the discussion also pertains to mounting along a vertical boundary of the viewing area such as 570 and or 572 in FIG. 5B. In some embodiments, infrared sensors are mounted along more than one boundary of a viewing area. The geometry of a viewing area, the response aperture of a sensor, and the desired spatial field for operational control by a user will determine how many sensors are required and the spatial distribution relative to the boundary of the viewing area.

A viewing area having rectangular geometry has been used for the discussion presented in the figures herein; however other geometries are used in other embodiments. For example, circular, oval, baroque, etc. are all suitable geometries for viewing areas. The techniques described above with respect to mounting a sensor proximate to a boundary and offset therefrom for rectangular geometries are applicable to any other geometry.

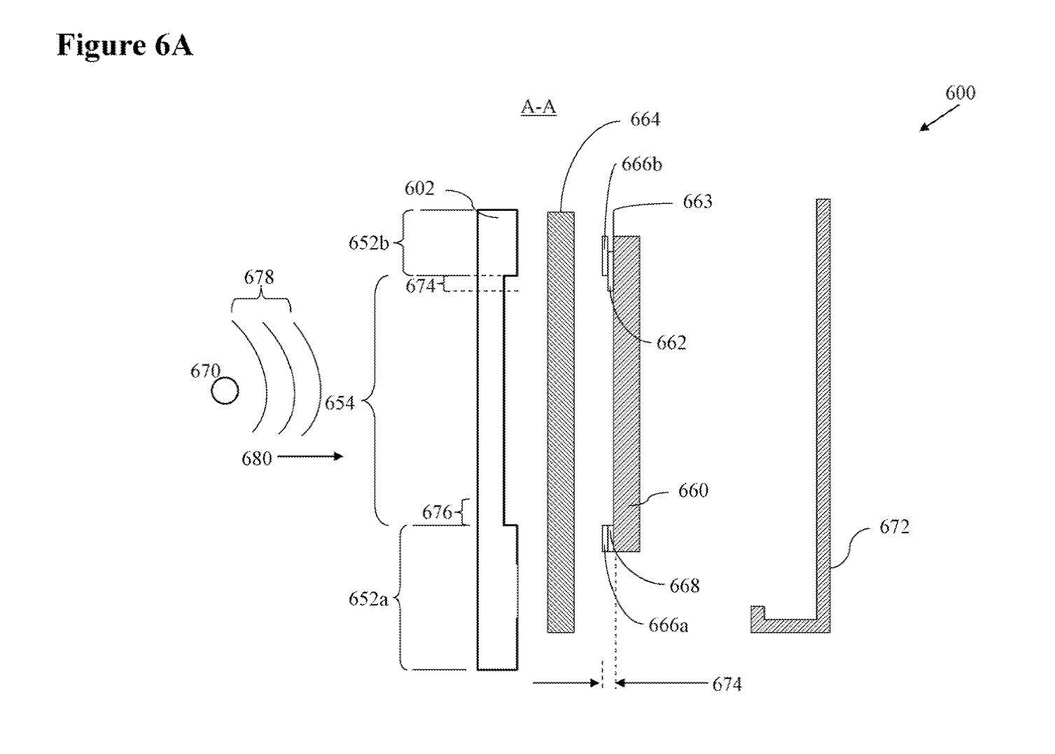

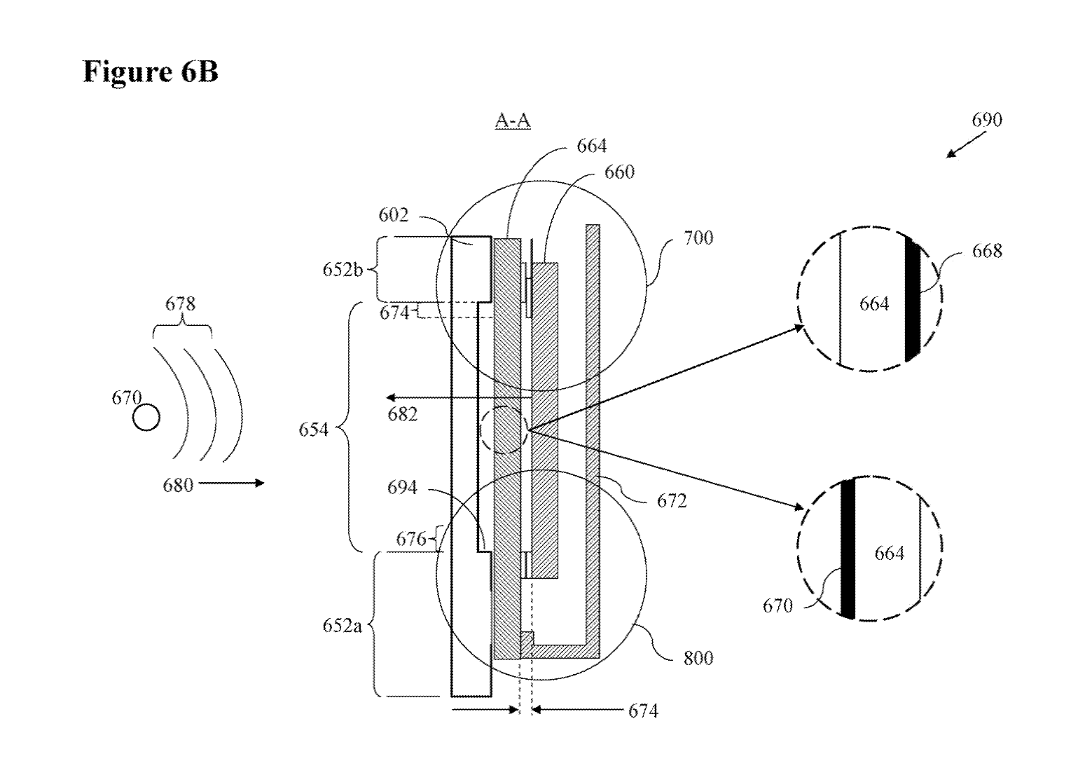

FIG. 6A illustrates, generally at 600, alternative embodiments of a vanishing system for a glass layer in exploded partial cross-sectional view, according to embodiments of the invention. FIG. 68B illustrates, generally at 690, the vanishing system from FIG. 6A in assembled view, according to embodiments of the invention.

With reference to FIG. 6A and FIG. 68B, a cross-sectional view of a glass layer 602 has a viewing area 654 and reflective areas 652a and 652b. The cross-sectional view 690 can correspond to the glass layer shown in front view in FIG. 3 at 300 for example. The mirror system illustrated in FIG. 6A and FIG. 68B contains a second glass layer 664. The second glass layer 664 includes a partially reflective coating 670 located either on a front side of a second glass layer 664 or alternatively a partially reflective coating 668 can be located on a back side of the glass layer 664. In some embodiments, the reflective coating is distributed on both a front side and a backside of the second glass layer 664. A reflectivity of the reflective coating is selected to create a two-way mirror which reflects when viewed from the front 680 but also allows light from a media display device 660 to pass through as indicated at 682. A housing 672 encompasses the media display device 660.

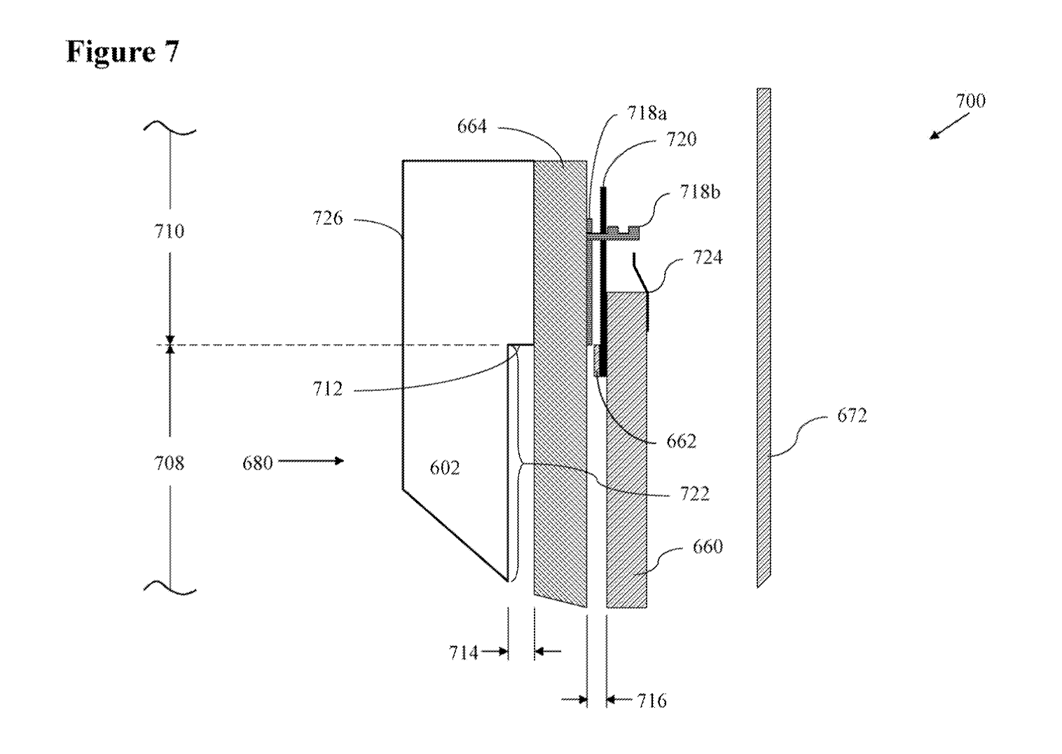

A sensor 662 is described in detail at 700 in the enlarged view of FIG. 7 below. In some embodiments, the sensor 662 is mounted on a mounting board 663 as described above in conjunction with FIG. 5A and FIG. 5B. In some embodiments, elements 666a and 666b function as spacers to adjust an offset distance 674 between the second glass layer 664 and the media display device 660. In some embodiments, elements 666a and 666b provide the dual function of spacing and adhesion of the sensor assembly 662/663 to the second glass layer 664 and the light assembly 668 to the second glass layer 664. In various embodiments, the sensor 662 and mounting board 663 are mounted within a sub panel or frame of the media display 660, thereby providing a flat surface for mating the media display device 660 to the second glass layer 664. The view of 662/663 provided in FIG. 6A/FIG. 68B is provided for illustration only and does not limit embodiments of the invention. The geometry established within FIG. 6A and FIG. 68B places the sensor 662 within the viewable area 654 by an amount represented by 674. An infrared control 670 emits wireless control signals 678 that are received by the sensor 662. These signals are processed and are used to control the media display device 660 as well as any other related electronics such as an audio signal emitted by the media display device 660. In yet other embodiments, in place of media display device 660 or in addition to media display device 660, additional electronic components are included within the vanishing system presented in the figures. Wireless control signals emitted by the control 670 are used to control various electronic components, such as, but not limited to lighting, a defogger, sound, video, etc.

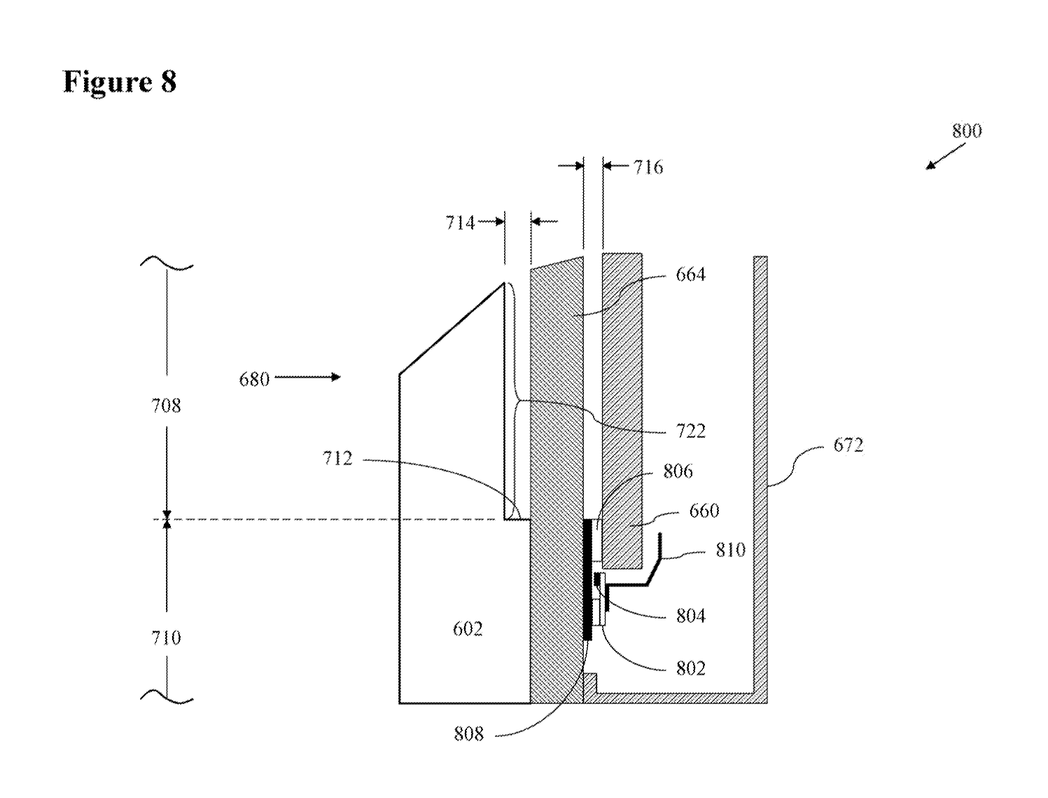

A light assembly 668 is described in detail at 800 in the enlarged view of FIG. 8 below. The light assembly 668 is electrically coupled to control circuitry used together with the infrared sensor 662 to indicate a state of the associated electronics. For example, a mirror defogger can be incorporated with the glass layer 602 and can be controlled with the vanishing systems described herein according to various embodiments of the invention. In other embodiments, devices used to generate sound such as a speaker or a transducer can be implemented and operated with the vanishing systems described herein according to embodiments of the invention. In yet other embodiments, lighting is incorporated into the glass layer 602 as either direct light or backlight or a combination of both. The lighting is controlled with the vanishing systems for the glass layer 602. The vanishing systems are used to render invisible the areas of the glass layer used for transmission of signals or system state indicator lights. The light assembly 668 is used in conjunction with such electronics to indicate a state associated therewith. Such as for example a state associated with: (a) powering up, (b) power on, (c) powering down, and (d) power off. The lighting assembly 668 emits light which is visible in a region of a boundary 694 of the viewing area 654 as indicated by a depth 676 into the viewing area 654.

In various embodiments, a color of the light or a movement of a light pattern can be associated with a state, such for example in one embodiment a green colored light is associated with the state of “powering up.” In another embodiment, a moving light pattern can be associated with a state of “powering up” which transitions to a stationary light when the “powering up” state is complete and the “power on” state is active. Such a constant light indicating the “power on” state can be associated with a mirror defogger being on and/or audio being active. In other embodiments, a light shuts off when steady state is achieved.

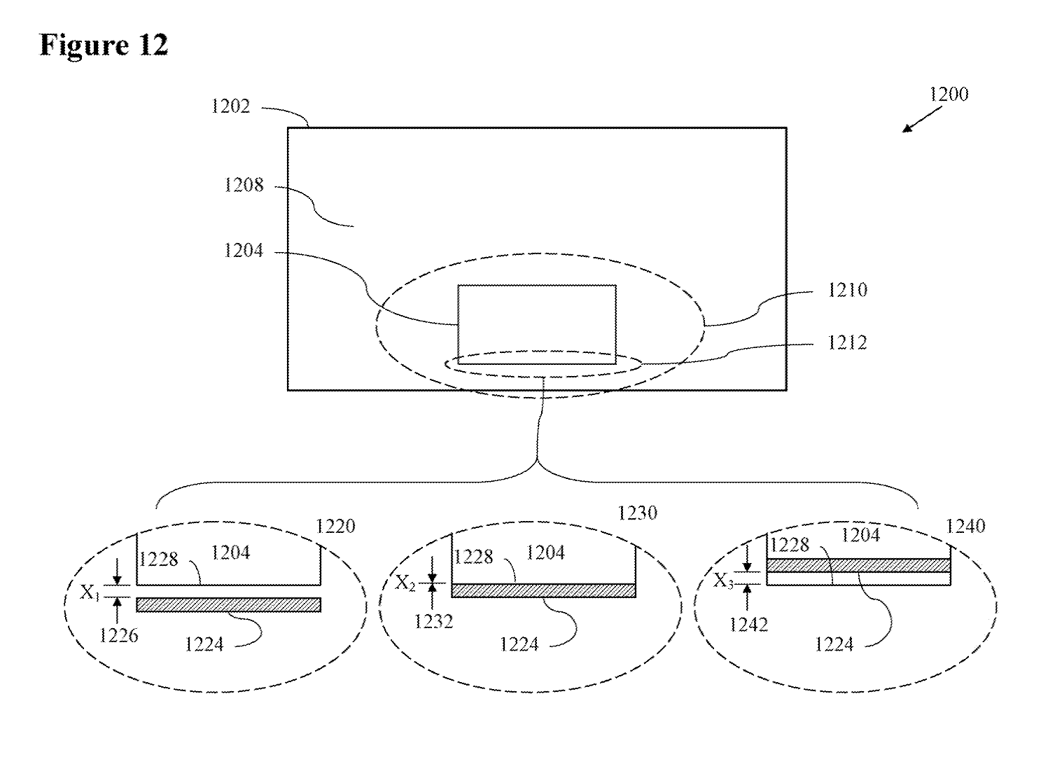

FIG. 7 illustrates, generally at 700, a close-up view of a sensor, from FIG. 6A/FIG. 6B, according to embodiments of the invention. With reference to FIG. 7, the glass layer 602 has a viewing area 708, a reflective area 710 and a boundary 712 separating the two areas. The boundary 712 extends into and out of the plane of the figure, as illustrated below by 1228 in FIG. 12. The second glass layer 664 is located on a back side the glass layer 602. A gap 714 exists between the glass layer 602 and the second glass layer 664 because of de-silvering of the glass layer 602 in the viewing area 708 on a rear side 722 of the glass layer 602. De-silvering can span a range of values as described above in the previous figures. A media display device 660 is located in back of the second glass layer 664. The media display device 660 forms a gap 716 with the second glass layer 664. A sensor 662 is located within the gap 716. A typical non-limiting example of the gap 716 dimension is on the order of 0.156 inch however the gap 716 is sized as needed. Note that the drawings are not to scale neither are the relative proportion of components shown therein accurate. Therefore, neither relative sizes or dimensions should not be inferred from the drawings. The gap 716 can be made smaller by moving glass layer 664 closer to the combination of 660/662/720. The infrared sensor 662 is typically mounted on a mounting board 720 as described in the previous figures to form a sensor assembly. The sensor assembly is coupled to either the media display device 660 or to the second glass layer 664 using two-way tape, epoxy, or other mechanical fixing by means of a clamp, bracket or other related fastener. The glass layer 602, the second glass layer 664, the sensor 662, and the media display device 660 are coupled together with various means such as two-way tape, etc. Mechanical fastening structures such as 718a and/or 718b and or 724 can be used in various embodiments to secure the components together into a suitable assembly. Mirror reflectivity in the viewing area 708 can be distributed between the glass layer 602 and the second glass layer 664 in various ways according to embodiments of the invention by varying the degree of de-silvering or silvering of a given mirror and/or through use of coatings, films, etchings, etc. In various embodiments, the sensor 662 and mounting board 720 are mounted within a sub panel or frame of the media display 660, thereby providing a flat surface for mating the media display device 660 to the second glass layer 664. The view of 662/720 provided in FIG. 7 is provided for illustration only and does not limit embodiments of the invention.

In some embodiments, the viewing area 708 of first glass layer 602 is substantially de-silvered. The second glass layer 664 is partially reflective, thereby providing a two-way mirror to an observer who views a front surface 726 of the glass layer 602 as indicated by a direction arrow 680. The vanishing mirror system provides a uniformly reflective surface when the media display device 660 is in an off state. In the off state, the observer cannot see the sensor 662 even though it is in the viewing area 708. A portion of a rear cabinet 672 is illustrated in the view of 700.

FIG. 8 illustrates, generally at 800, a close-up view of a light indicator assembly, from FIG. 6A/FIG. 6B, according to embodiments of the invention. With reference to FIG. 8, an indicator light board 802 is located on a back side of the second glass layer 664. The light board 802 contains at least one indicator light 804. Proximate to the indicator light 804 is an indicator light guide 806. Light from the indicator light 804 illuminates the indictor light guide 806. The indicator light guide 806 is placed in the gap 716 in between the second glass layer 664 and the media display device 660. In some embodiments, the second glass layer 664 is partially reflective, thereby providing a two-way mirror to an observer viewing from a direction indicated by an arrow 680. The vanishing mirror system provides a uniformly reflective surface when the media display device is in an off state. In the off state, the observer cannot see the indicator light guide even though a portion of it might be located in the viewing area 708. Configured as described, the indicator light guide 806 is not visible when the indicator light 804 is not radiating light even though the indicator light guide 806 is in the viewing area 708 since it is located behind the second glass layer 664 which is functioning as a two-way mirror. When the indicator light 804 is turned on light radiates from the indicator light guide 806 and illuminates the viewing area 708 along a boundary 712 between the viewing area 708 and the reflective area 710. The indicator light is used to inform the user that the media display device 660 (or other electronics) is being powered up or powered down. A single color or multiple colors are used for the indicator light. In one non-limiting example, a green color is used to signify powering up and a shade of red is used to indicate powering down. In other non-limiting examples the same color is used to indicate powering up and powering down. In yet other non-limiting examples, a green color is used to indicate powering up and an orange color is used to indicate powering down. In various embodiments, the indicator light system is used to communicate other information to a user such as a state of the electronics associated with the glass layer such as for example, on, off, standby, etc.

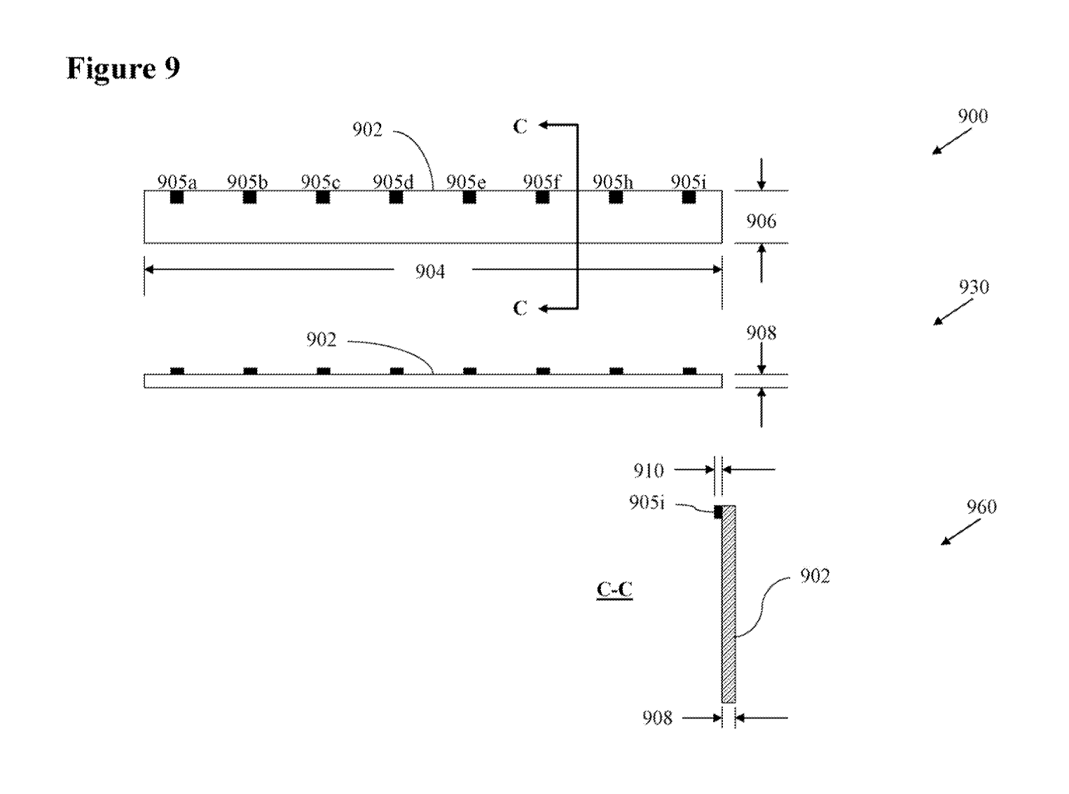

FIG. 9 illustrates, generally at 900, a plurality of light sources according to embodiments of the invention. With reference to FIG. 9, a top view of an indicator light board 902 is shown in 900. The indicator light board 902 has a length indicated at 904 and a width indicated at 906. The top view shown in 900 of the indicator light board 902 shows a plurality of light sources 905a through 905i. The plurality of light sources is shown in the figure, however only one light source is needed to provide the indicator light function as described above in conjunction with the previous figures such as FIG. 8, etc. The indicator light board 902 is displayed in edge view at 930. The indicator light board 902 has a thickness 908. In various embodiments, the indicator light board 902 can be made from different materials. In one or more embodiments, the indicator light board 902 is made from fiberglass or plastic and is referred to commonly as a printed circuit board or PCB board.

The light sources 905a through 905i can be made using a variety of technologies. In various embodiments, semiconductor fabrication technologies are used to make the light sources from a light emitting diode (LED). When a plurality of light sources 905 are used, they are typically distributed along an edge of the board 902 so that light is emitted evenly into a light guide. Power is provided to the LEDs by means of conductive traces (not shown) placed on the indicator light board and additionally in some embodiments LED driver circuits (not shown) can be provided as separate integrated circuits (IC) or as ICs located on the indicator light board 902 as well as ICs that are located with the light source on the same chip.

A cross-sectional view C-C is illustrated at 960. In the cross-sectional view 960, the indicator light board 902 is illustrated with a thickness 908 and at least one light source 905i. In different embodiments, various aspect ratios are made for the indicator light board 902 by varying the length 904, the width 906, and the thickness 908 for a given application.

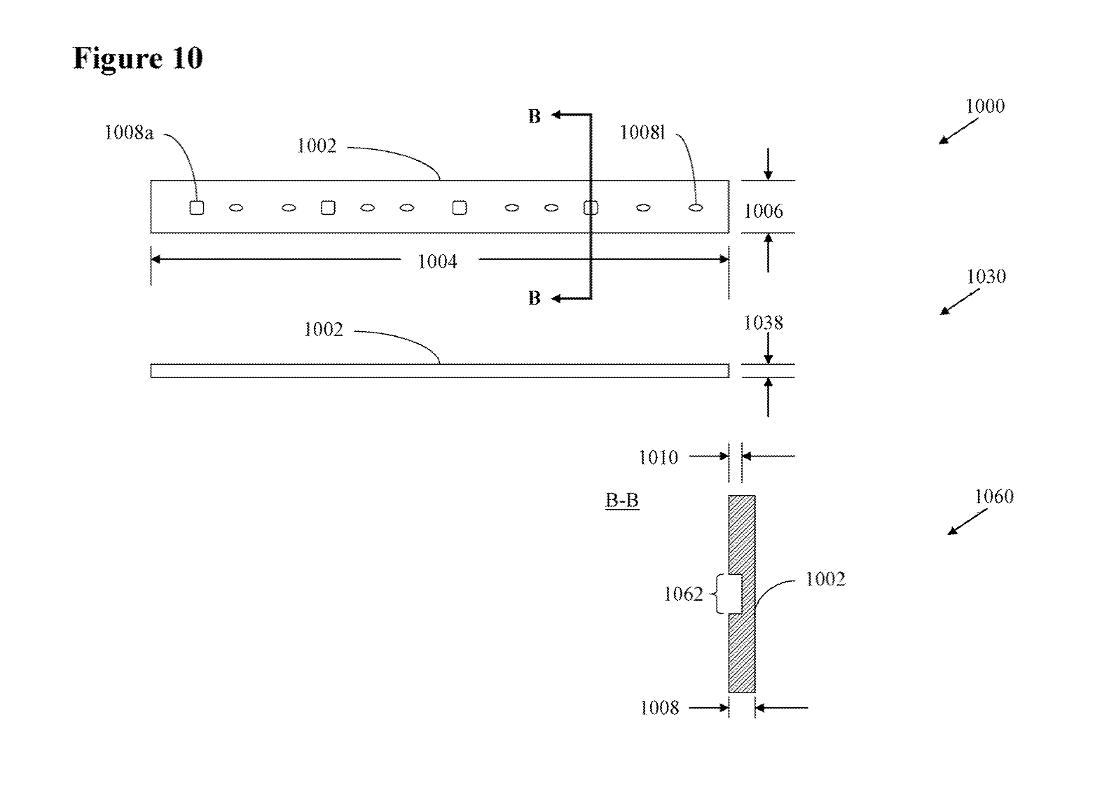

FIG. 10 illustrates a light guide according to embodiments of the invention. With reference to FIG. 10, a top view of an indicator light guide 1002 is illustrated at 1000. The indicator light guide 1002 has a length indicated at 1004 and a width indicated at 1006. One or more recessed areas are indicated at 1008a through 1008l. Only 1008a and 1008l are labeled to preserve clarity in the figure. These recessed areas are optional and are generally used to facilitate mounting the light guide to adjacent parts in the assembly.

The light guide 1002 is illustrated in edge view in 1030 with a thickness indicated at 1038. The light guide is generally made from translucent or transparent material to facilitate the transmission of light through the light guide. Some non-limiting examples of material are but are not limited to glass or plastic such as acrylic, etc.

A cross-sectional view B-B is illustrated in 1060. An indentation 1062 is illustrated producing a reduction in thickness as indicated by 1010. In different embodiments, various aspect ratios are created for the light guide 1002 by varying the length 1004, the width 1006, and the thickness 1008 for a given application with consideration given for the dimensions of the associated light board (e.g. as shown in FIG. 9) and gap within which the light will be placed (e.g. as shown in FIGS. 1, 3, 6A, 6B, 7).

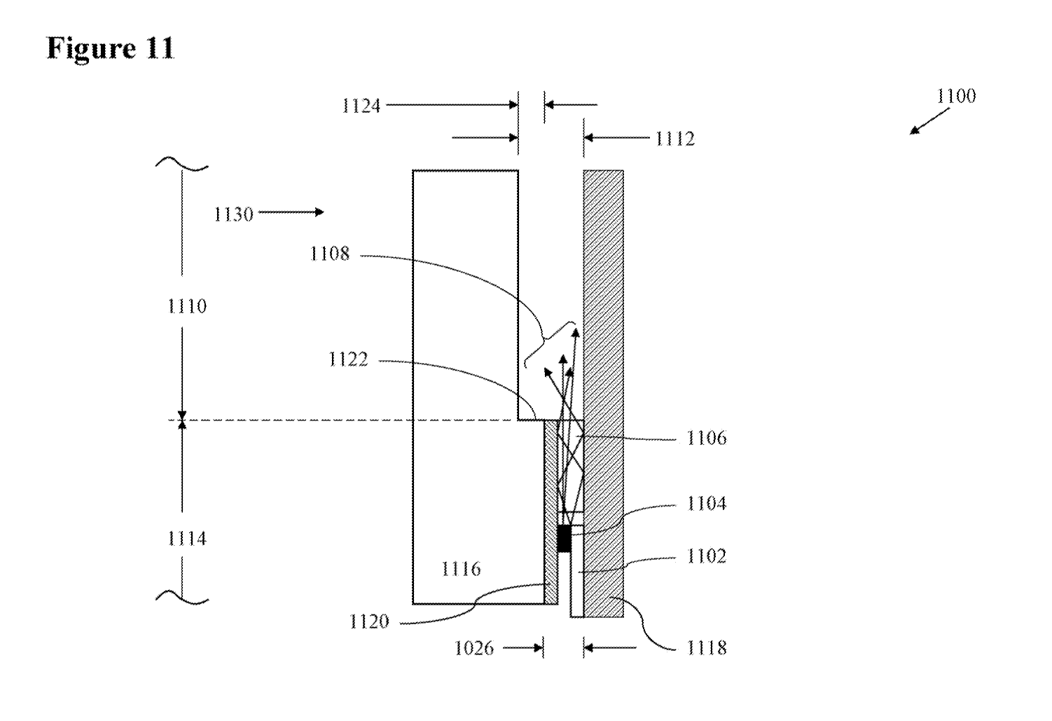

FIG. 11 illustrates, generally at 1100, a cross-sectional view of an indicator light assembly according to embodiments of the invention. With reference to FIG. 11, a glass layer 1116 has a substantially reflective portion 1114 and a portion 1110 with a reflectivity which is less than the reflectivity of the substantially reflective portion 1114. The reflectivity of the portion 1110 is reduced by removal of silvering from a back side of the glass layer 1116 as indicated by a reduction in thickness indicated at 1124.

A layer 1118 can represent a media display device or a second glass layer as described above. The view presented in FIG. 11 is a close-up view similar in perspective to that shown in FIG. 8 above. An indicator light assembly is assembled within a gap 1126 between the glass layer 1116 and the second layer 1118. In various embodiments, the indicator light assembly includes an indicator light board 1102, one or more light sources indicated by 1104, a light guide 1106, and a layer 1120 which can be a mounting board for the aforementioned components. In some embodiments, a layer 1120 is an adhesive layer. In yet other embodiments, a layer 1120 is a spacer and one or more adhesive layers which are used to fix the elements in place. An adhesive layer can be a layer of two-way tape, epoxy, etc. In various embodiments, the indicator light assembly is mounted within a sub panel or frame (envelope) of the media display 1118 (FIG. 11), thereby providing a flat surface for mating the media display device 1118 to the glass layer 1116. The view of the indicator light assembly provided in FIG. 11 is provided for illustration only and does not limit embodiments of the invention. Similarly, the indicator light assembly shown in the figures above can be incorporated into an envelope of a media display device as described herein.

In operation, light is emitted from the light source 1104 and is guided by the light guide 1106 into a gap 1112 of the region 1110 of the glass layer 1116 as indicated at 1108. A user who observes the glass layer 1116 from a direction indicated by an arrow 1130 will see the light 1108 illuminating a boundary 1122 between the substantially reflective portion 1114 and the portion 1110 of the glass layer 1116. Note that in some embodiments, the indicator light guide 1106 can extend behind the portion 1110 which places the indicator light guide into the viewing area.

FIG. 12 illustrates, generally at 1200, different placements for a light guide according to embodiments of the invention. With reference to FIG. 12, a glass layer 1202 has a substantially reflective portion indicated at 1208 with a portion 1204 having a reflectivity which is less than a reflectivity of the substantially reflective portion 1208. In various embodiments, the reflectivity of the portion 1204 can be selected from a wide range of values ranging from transparent to substantially reflective. In some embodiments, the reflectivity is on the order of a reflectivity of a two-way mirror. Thus, an appearance of a mirror can exist across a spectrum depending on a particular embodiment of the invention. At one end of the spectrum, the appearance is such that the portion 1204 is visibly different from the appearance of 1208 because of the difference in reflectivity between the two portions of the glass layer 1202. At the other end of the spectrum the appearance is such that portion 1208 and portion 1204 blend into one another without any noticeable border between the two portions.

In some embodiments, a media display device is located behind the portion 1204 and is configured to disappear into the glass layer 1202 when in an off state. When in an on state, the media display device is visible since enough of its emitted light can pass through the portion 1204.

In various embodiments, an indicator light is incorporated into a region 1210 of the glass layer 1202. The region 1210 includes the portion 1204. The indicator light is configured to illuminate a portion of a boundary between the portion 1208 and the portion 1204. In the example of FIG. 12, the portion 1204 is in the shape of a rectangle, no limitation is implied by use of a rectangular shape for the portion 1204. Embodiments of the invention are equally applicable to all shapes for the boundary, such as a triangular shape, a square shape, an oval shape or a baroque shape.

In this illustration, the region under discussion is the lower horizontal boundary of the region 1204 indicated at 1212. Three different placements of the indicator light assembly are shown in inset views 1220, 1230, and 1240 for the region 1212.

In inset view of 1220, a light guide 1224 (part of an indicator light assembly) is located a distance X₁ indicated at 1226 from the boundary 1228 of the portion 1204. In another embodiment, inset view 1230, a light guide 1224 (part of an indicator light assembly) is located a distance X₂ indicated at 1232 from the boundary 1228 of the portion 1204. In the illustration of 1230 an edge of the light guide is located at an edge of the portion 1204 along the boundary 1228. In another embodiment, inset view 1240, a light guide 1224 (part of an indicator light assembly) is located a distance X₃ indicated at 1242 from the boundary 1228 of the portion 1204. In the illustration of 1240 the light guide 1224 is within the portion 1204.

In other embodiments, a media display device is located behind the portion 1204 and is configured to remain visible when in an off state. In such a configuration, the reflectivity of the portion 1204 is low enough relative to a reflectivity of the portion 1208 for the portion 1204 to be visibly different from the portion 1208 when the media display device is in an off state. As described previously in conjunction with the previous figures, an indicator light assembly can be configured along any boundary or portion of a boundary or multiple boundaries. The discussion presented herein is merely illustrative and is not meant to limit embodiments of the invention in any way.

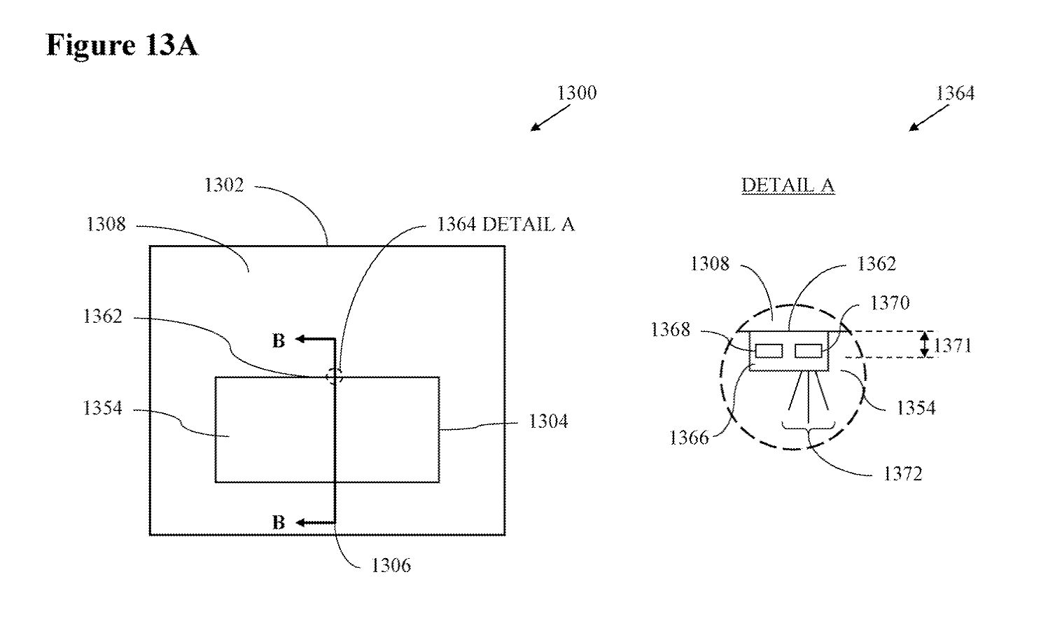

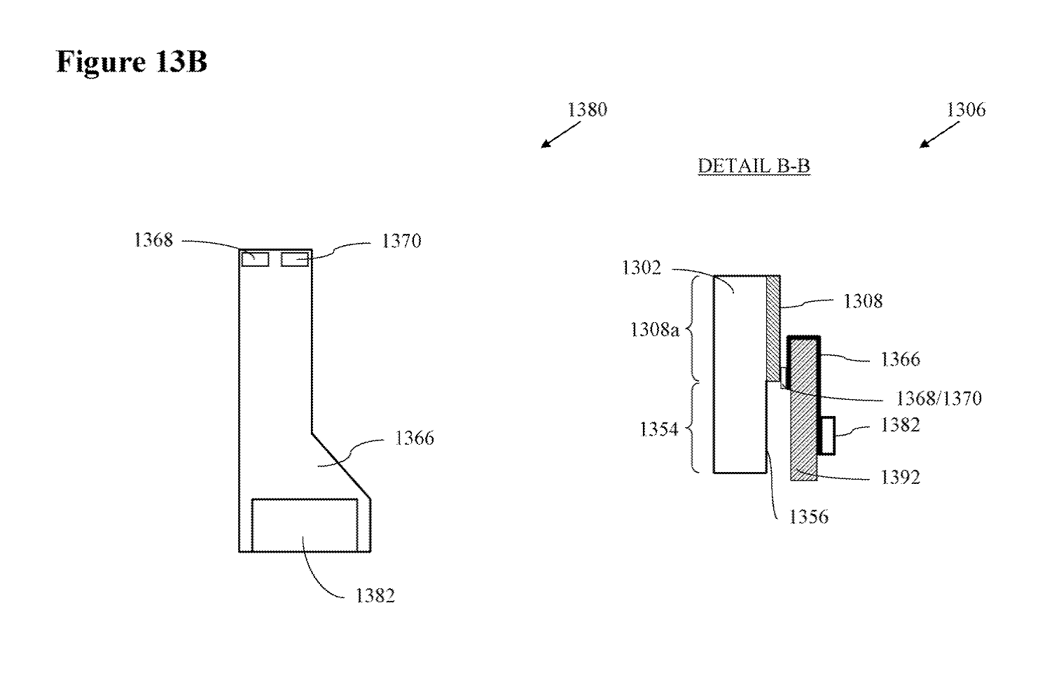

In some embodiments, a sensor and its associated control electronics are located with the indicator light board, thereby reducing parts count and simplifying installation of the components. In other embodiments, an indicator light(s) and a sensor(s) and the associated control electronics are located together on the same board or mounting surface. Such a configuration also reduces the parts count and system complexity. An example of incorporating an indicator light(s) together with a sensor(s) according to various embodiments is illustrated in FIG. 13A and FIG. 13B.

Referring now to FIG. 13A at 1300, a glass layer 1302 has a reflective portion 1308 and in some embodiments, a viewing portion 1304. A cross-sectional view B-B 1306 is presented in FIG. 13B.

With reference to FIG. 13A-13B and DETAIL B-B 1306, the glass layer 1302 (shown in cross-section) has a reflective area indicated by 1308a (which is a representative portion of 1308 from 1300) and a viewing area indicated at 1354a (which is a representative portion of 1354 from 1300). In some embodiments, a reflective layer (and backing layer if present) has been removed (de-silvered) from a back side 1356 of the glass layer 1302 over an area indicated by 1354 in order to create the viewing portion 1304, rendering the viewing area 1354 virtually transparent. In other embodiments, a reflective layer is not completely removed from the back side 1356 of the glass layer 1302. In such embodiments, the reflectivity of the glass layer 1302 is reduced across the viewing area 1354 relative to the reflectivity of the reflective area 1308. Embodiments of the invention permit a limitless number of different reductions in reflectivity of the viewing area 1354 relative to the reflective area 1308. A non-limiting example of a reflectivity of the reflective area is a reflectivity of approximately 50%. Many different values can be used for this reflectivity and embodiments of the invention are not limited by a value selected. In various embodiments, reflectivities can range from zero up to a value that provides two-way mirror functionality.

In some embodiments a media display device 1392 is located on the back side of the glass layer 1302 and the media display device 1392 covers the viewing area 1354. As shown in DETAIL A at 1364 and in FIG. 13B, a sensor 1370, for receiving wireless signals, is mounted in between the glass layer 1302 and the media display device 1392. The sensor 1370 is located within the viewing area 1354 along a boundary 1362 between the viewing area 1354 and the reflective area 1308. The sensor 1370 extends into the viewing area by an amount indicated by 1371. In various embodiments, the sensor 1370 is incorporated on a mounting board 1366. The mounting board 1366 facilitates mechanical mounting and in some embodiments electrical connection of the sensor by means of circuitry not shown in FIG. 13A/13B. In some embodiments, the mounting board 1366 is a flexible printed circuit board that is bent around the media display device 1392 as shown in DETAIL B-B of FIG. 13B. In some embodiments the mounting board is clear or substantially clear. In some embodiments, the printed circuit board 1366 has an electrical connector 1382 which is used to provide electrical connection with the control electronics and electrical device under control which are described elsewhere herein. In some embodiments the connector 1382 is commonly know in the art as a JST connector (Japan solderless terminal from J.S.T. Manufacturing Co.). Other connectors can be used and other means of connection can be used such as for example soldering or riveting.

In some embodiments, a light source 1368 is incorporated onto the mounting board 1366. In some embodiments, the light source 1368 is a light emitting diode (LED) in other embodiments the light source 1368 is constructed from a device different from a light emitting diode. The mounting board 1366 can provide a source of electrical power as needed to the light source 1368 by means of electrical connections which are not shown to preserve clarity in the figures. In some embodiments, the mounting board 1366 is a flexible circuit board. In some embodiments, the flexible circuit board is clear or substantially clear.

Combining a light source, such as 1368, with a sensor, such as 1370, onto a single mounting board, such as 1366, reduces the number of parts required for the system thereby reducing the cost of construction. The mounting board 1366 can be attached to the media display device 1392 or to a different component in various ways. In one or more embodiments, two-way tape is used to attach the mounting board 1366 to the media display device 1392. In other embodiments, mechanical brackets are used for attachment. In yet other embodiments, the mounting board is attached to a back side of the glass layer 1302. In various embodiments, the sensor 1368, light source 1370, and mounting board 1366 are mounted within a sub panel or frame of the media display 1392, thereby providing a flat surface for mating the media display device 1392 to the glass layer 1302. The view of 1368/1370/1366 provided in FIG. 13A/FIG. 13B is provided for illustration only and does not limit embodiments of the invention.

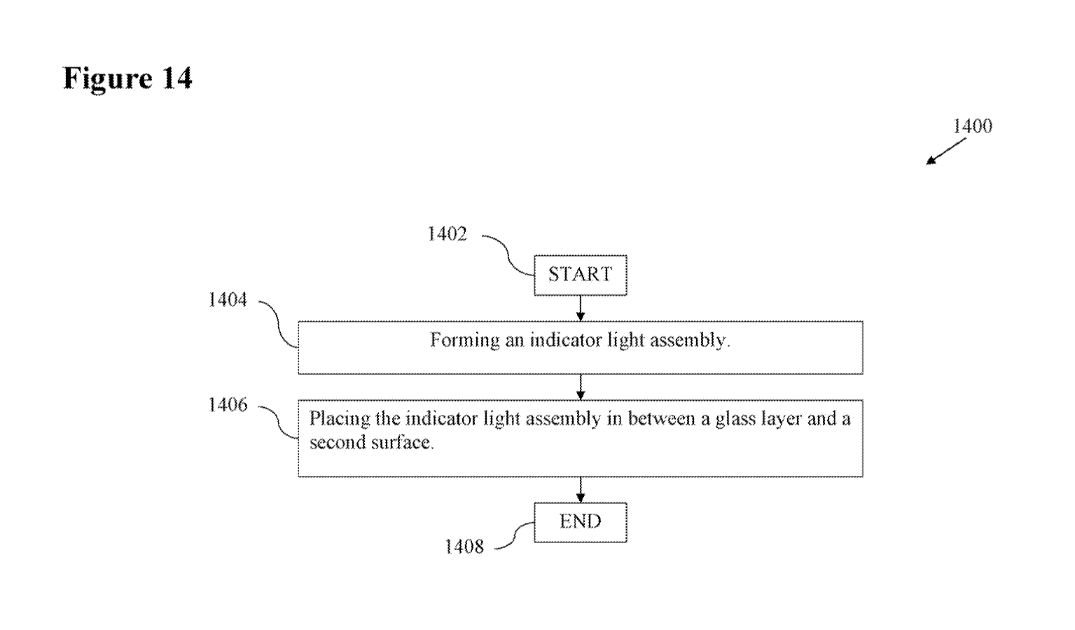

FIG. 14 illustrates, generally at 1400, a process to form an indicator light assembly according to embodiments of the invention. With reference to FIG. 14, a process starts at a block 1402. At a block 1404 an indicator light assembly is formed. Indicator light assemblies have been described above in conjunction with the preceding figures such as FIG. 3, FIG. 6A, FIG. 6B, FIG. 8, FIG. 10, FIG. 11, FIG. 12, and FIG. 13A/13B as well as in other figures. At a block 1406 an indicator light assembly is placed between a glass layer and a second surface. The indicator light assembly is located to facilitate illumination of a boundary between two portions of a glass layer where the reflectivity of the portions differ from each other. In various embodiments, the indicator light assembly includes a light guide. The light guide can be located outside of a viewing area of a media display device that is mounted behind the glass layer. The process stops at a block 1408.

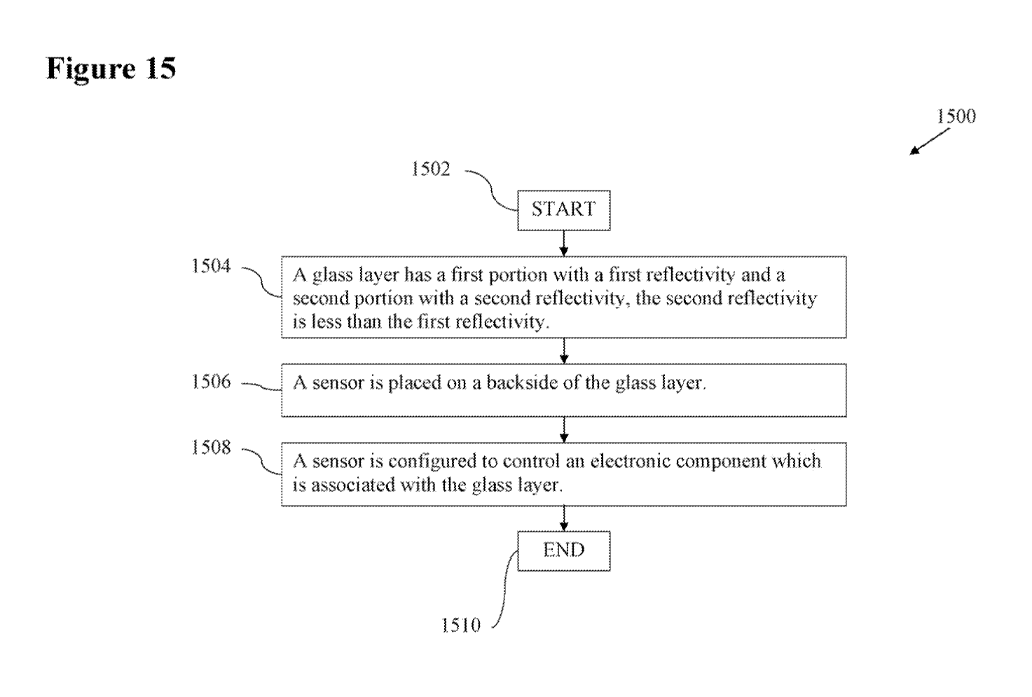

FIG. 15 illustrates, generally at 1500, a process to form a sensor assembly according to embodiments of the invention. With reference to FIG. 15, a process starts at a block 1502. At a block 1504 a glass layer has a first portion with a first reflectivity and a second portion with a second reflectivity. The second reflectivity is less than the first reflectivity. At a block 1506 a sensor is placed within the second portion on a back side of the glass layer, such as is described above in conjunction with FIG. 2, FIG. 3, FIG. 4, FIG. 5A, FIG. 5B, FIG. 6B, FIG. 6B, FIG. 7, and FIG. 9 as well as in other figures. At a block 1508 a sensor is configured to control an electronic component which is associated with the mirror. The process stops at a block 1510.

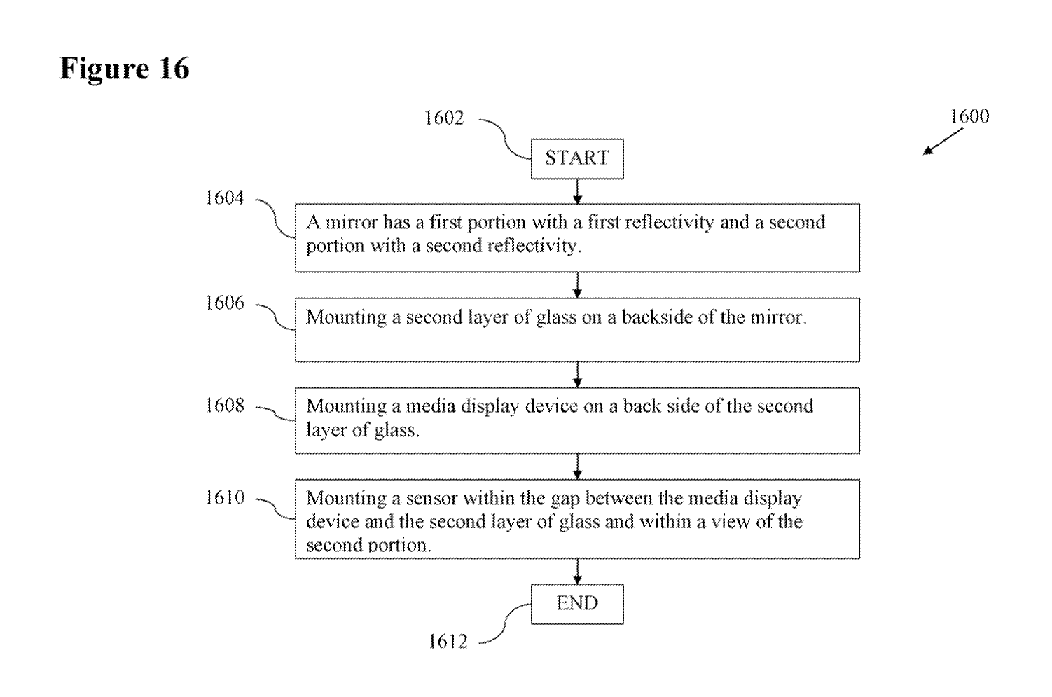

FIG. 16 illustrates, generally at 1600, a process to create a vanishing mirror system according to embodiments of the invention. With reference to FIG. 16, a process starts at a block 1602. At a block 1604 a mirror (glass layer) has a first portion with a first reflectivity and a second portion with a second reflectivity. The second reflectivity is less than the first reflectivity. At a block 1606 a second layer of glass is mounted on a back side of the mirror. A second layer of glass has been described above in conjunction with FIG. 6A and FIG. 6B, as well as in other figures. In some embodiments, the second layer of glass is partially reflective as described above. At a block 1608 a media display device is mounted on a back side of the second layer of glass behind the second portion of the mirror. A gap is created between the second layer of glass and the media display device. At a block 1610 a wireless sensor is mounted within the gap between the media display device and the second layer of glass. In some embodiments, the sensor mounting places the sensor behind the second portion of the mirror. In other embodiments, the sensor mounting places the sensor behind the first portion of the mirror. In some embodiments, the sensor is not visible when viewed from a front side of the mirror. A process stops at a block 1612.

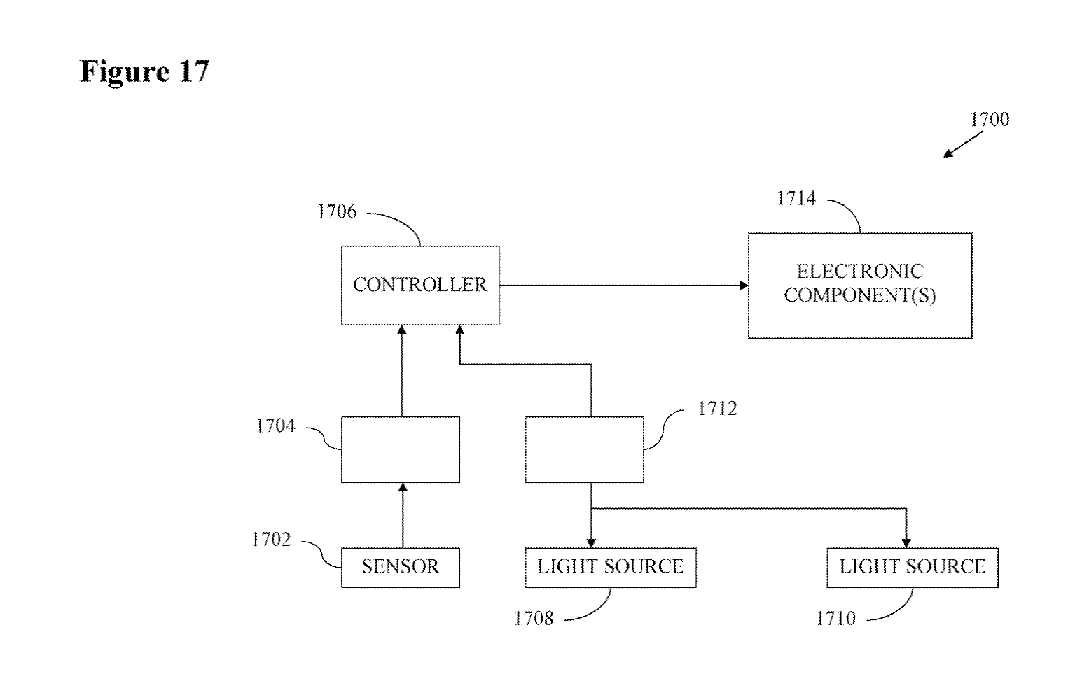

FIG. 17 illustrates, generally at 1700, a block diagram of a control system for electronics, according to embodiments of the invention. With reference to FIG. 17, a wireless sensor is indicated at 1702. The wireless sensor 1702 has been described above in conjunction with the preceding figures.

Sensor control electronics are indicated at 1704 and can be provided as an integrated circuit either separately or incorporated together on a single integrated circuit. A light source is indicated at 1708. The light source can be a light emitting diode (LED) or other technology can be used to make the light source. In some embodiments a plurality of light sources are used and is indicated by 1710. The light source 1708 has been described above in conjunction with the preceding figures. Light source control electronics is indicated at 1712.

A controller 1706 is coupled to the sensor control electronics 1704 and the light source control electronics 1712. Electronics 1714 is associated with a glass layer and can be any one or more of a media display device, a defogger, a light source, a speaker, etc. The electronics 1714 is electrically coupled to the controller 1706.

In operation, the sensor 1702 receives wireless control signals from a transmitter operated by a user. The control signals are used to control the electronics 1714. An indication of the state of the electronics 1714 is communicated to the user through indicator light 1708 through 1710. As described above in conjunction with the preceding figures the control system is invisible to the user who views the glass layer from the front side. Visual indicia of the indicator lights appear to vanish into the glass layer.

For purposes of discussing and understanding the embodiments of the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

Any of the methods according to the present invention can be implemented in hard-wired circuitry (e.g., integrated circuit(s)), by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods herein may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

Non-transitory machine-readable media is understood to include any mechanism for storing information in a form readable by a machine (e.g., a computer). For example, a machine-readable medium, synonymously referred to as a computer-readable medium, includes read only memory (ROM); random access memory (RAM); magnetic disk storage media; optical storage media; flash memory devices; except electrical, optical, acoustical or other forms of transmitting information via propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

What is claimed is:

1. A vanishing system, comprising:
a first glass layer, the first glass layer has a front side, a back side, a viewing area, and a reflective area, the viewing area is substantially transparent;
a second glass layer, the second glass layer has a front side, a back side, and a partially reflective layer, the partially reflective layer is on the front side of the second glass layer or the back side of the second glass layer, the second glass layer covers the viewing area on the back side of the first glass layer; and
a sensor having a length and a width, the sensor is located on the back side of the second glass layer, and the first glass layer and the second glass layer are coupled together, and the sensor is configured to receive wireless signals.

2. The vanishing system of claim 1, further comprising:
a media display device, the media display device is located on the back side of the second glass layer and covers the viewing area.

3. The vanishing system of claim 2, wherein the sensor is coupled to the media display device and media display device is coupled to at least one of the first glass layer or the second glass layer and the sensor is within the viewing area.

4. The vanishing system of claim 1, wherein the sensor is an infrared sensor.

5. The vanishing system of claim 3, further comprising:
an indicator light board, the indicator light board has a length, a width, and a thickness, the indicator light board has at least one light source distributed along the length of the indicator light board, the thickness of the indicator light board is sized to permit the indicator light board to fit in a gap between the second glass layer and the media display device; and
an indicator light guide, the indicator light guide has a length, a width, and a thickness, the length of the indicator light guide is sized to permit light from the at least one light source to radiate into the indicator light guide and into the viewing area.

6. The vanishing system of claim 5, wherein the indicator light guide is located in between the second glass layer and the media display device behind the reflective area and along a boundary of the viewing area.

7. The vanishing system of claim 1, further comprising:
at least one dark strip having a length and a width, the width of the at least one dark strip is substantially equivalent to the width of the sensor, the at least one dark strip is positioned proximate to the sensor, the sensor and the at least one dark strip are mounted in the viewing area along a boundary of the viewing area.

8. The vanishing system of claim 6, wherein the at least one dark strip is made from plastic.

9. The vanishing system of claim 7, wherein the at least one dark strip is made from a substantially opaque material.

10. The vanishing system of claim 5, wherein the sensor is incorporated with the indicator light board.

11. The vanishing system of claim 1 further comprising:
a mounting board, the mounting board is configured for mounting the sensor; and
an indicator light, the mounting board is configured for mounting the indicator light.

12. The vanishing system of claim 11 wherein the sensor is selected from the group consisting of an infrared sensor, a sensor utilizing the Bluetooth protocol, a sensor utilizing the ZigBee protocol, a sensor utilizing the WiFi protocol, a sensor using a user defined wireless protocol.

13. The vanishing system of claim 11 wherein the indicator light is a light emitting diode (LED).

14. The vanishing system of claim 11 wherein the mounting board is a flexible printed circuit board.

15. The vanishing system of claim 14 wherein the mounting board is substantially clear.

16. A vanishing system, comprising:
a first glass layer, the first glass layer has a front side, a back side, a viewing area, and a reflective area, the viewing area is substantially transparent;
a media display device, the media display device is located on the back side of the first glass layer and the media display device covers the viewing area; and
a sensor having a length and a width, the sensor is located within the viewing area in between the first glass layer and the media display device, the media display device the first glass layer and the sensor are coupled together, and the sensor is configured to receive wireless signals.

17. The vanishing system of claim 16, further comprising:
a second glass layer, the second glass layer has a front side, a back side, and a partially reflective layer, the partially reflecting layer is in contact with one of the front side of the second glass layer or the back side of the second glass layer, the second glass layer covers the viewing area on the back side of the first glass layer.

18. The vanishing system of claim 16, further comprising:
an indicator light board, the indicator light board has a length, a width, and a thickness, the indicator light board having at least one light source located along the length of the indicator light board, the indicator light board is configured to permit the at least one light source to illuminate a gap between the first glass layer and the media display device;
an indicator light guide, the indicator light guide has a length, a width, and a thickness, the length of the indicator light guide is sized to permit light from the at least one light source to radiate into the indicator light guide and into the viewing area and the thickness of the indicator light guide is sized to permit the indicator light guide to fit in between the media display device and the first glass layer.

19. The vanishing system of claim 18, wherein the indicator light guide is located in between the first glass layer and the media display device and along a boundary of the viewing area.

20. The vanishing system of claim 16, further comprising:
at least one dark strip having a length and a width, the width of the at least one dark strip is substantially equivalent to the width of the sensor, the at least one dark strip is positioned proximate to the sensor and the sensor and the at least one dark strip are mounted in the viewing area along a boundary of the viewing area.

21. The vanishing system of claim 16, wherein the sensor is an infrared sensor.

22. The vanishing system of claim 16, wherein the reflective area and the viewing area have the same reflectivity.

23. The vanishing system of claim 16, wherein the reflective area and the viewing area are transparent.

24. The vanishing system of claim 16, wherein the reflective area and the viewing area are substantially transparent.

25. A vanishing system, comprising:
a first glass layer, the first glass layer has a front side, a back side, a viewing area, and a reflective area, a reflectivity of the viewing area is less than a reflectivity of the reflective area;
a media display device, the media display device is located on the back side of the first glass layer and the media display device covers the viewing area; and
an indicator light, the indicator light is located outside of the viewing area over the reflective area on the back side of the first glass layer in between the first glass layer and the media display device, and the sensor is configured to receive wireless signals, when the indicator light is on light emitted from the indicator light illuminates a part of the viewing area.

26. The vanishing system of claim 25, further comprising:
a light guide, the light guide is located in between the first glass layer and the media display device and the light guide is located in between the indicator light and a boundary of the viewing area, the light guide guides light from the indicator light to illuminate the viewing area when the media display device is powering up.

27. The vanishing system of claim 26, further comprising:
a sensor, the sensor is configured to receive wireless signals and the sensor is located within the viewing area in between the first glass layer and the media display device, the media display device, the first glass layer, and the sensor are coupled together.

28. The vanishing system of claim 25, wherein the viewing area is substantially transparent.

29. The vanishing system of claim 25, wherein the reflectivity of the viewing area provides a two-way mirror.

30. The vanishing system of claim 25, further comprising:
a second glass layer, the second glass layer has a front side, a back side, and a partially reflective layer, the partially reflecting layer is in contact with one of the front side of the second glass layer or the back side of the second glass layer, the second glass layer covers the viewing area on the back side of the first glass layer, the media display device is located on the back side of the second glass layer and the indicator light is located on the back side of the first glass layer.

31. The vanishing system of claim 27, wherein the sensor is an infrared sensor.

32. The vanishing system of claim 25 further comprising:
a sensor, the sensor is configured to receive wireless signals; and
a mounting board, the mounting board is configured for mounting the sensor and the mounting board is configured for mounting the indicator light.

33. The vanishing system of claim 32 wherein the sensor is selected from the group consisting of an infrared sensor, a sensor utilizing the Bluetooth protocol, a sensor utilizing the ZigBee protocol, a sensor utilizing the WiFi protocol, a sensor using a user defined wireless protocol.

34. The vanishing system of claim 32 wherein the indicator light is made with a light emitting diode (LED).

35. A vanishing system, comprising:
an indicator light board, the indicator light board has a length, a width, and a thickness;
a plurality of light sources, the plurality of light sources are distributed along the length, the indicator light board is configured to permit the plurality of light sources to illuminate a gap between a first glass layer and a media display device, the length is sized to permit the plurality of light sources to extend along a boundary of a viewing area of the first glass layer; and
an indicator light guide, the indicator light guide has a length, a width, and a thickness, the length of the indicator light guide is sized to permit light from the plurality of light sources to radiate into the indicator light guide and into the viewing area and the thickness of the indicator light guide is sized to permit the indicator light guide to fit in between the media display device and the first glass layer.

36. The vanishing system of claim 35, wherein the indicator light board is made up from a plurality of indicator light boards.

37. The vanishing system of claim 36, wherein the indicator light guide is made up from a plurality of indicator light guides.

38. A method to create a vanishing system, comprising:
locating a sensor on a back side of the glass layer, the sensor is configured to receive wireless signals;
locating an indicator light on the back side of the glass layer outside of a viewing area of the glass layer;
combining a media display device with the glass layer wherein the media display device is placed over the viewing area, on the back side of the glass layer, wherein the indicator light is captured between the glass layer and the media display device, the media display device is responsive to received wireless signals by the sensor; and
securing the glass layer, the sensor, the indicator light, and the media display device together to form an assembly wherein the sensor is not visible to an observer on a front side the glass layer and light emitted from the indicator light, in response to wireless signals received at the sensor, is temporarily visible when the indicator light is on.

39. The method of claim 38, further comprising:
locating a second glass layer in between the glass layer and the media display device, wherein the sensor is placed in between the second glass layer and the media display device and the indicator light is placed in between the second glass layer and the media display device.

40. The method of claim 38, wherein the sensor is located within the viewing area and along a boundary of the viewing area.

41. The method of claim 38, wherein the indicator light is located along a boundary of the viewing area.

42. The method of claim 38, wherein the sensor is an infrared sensor and the indicator light is made with a light emitting diode (LED).
